(19) United States
(12) Patent Application Publication
(10) Pub. No.: US 2015/0139601 A1
(43) Pub. Date: May 21, 2015

(54) METHOD, APPARATUS, AND COMPUTER PROGRAM PRODUCT FOR AUTOMATIC REMIX AND SUMMARY CREATION USING CROWD-SOURCED INTELLIGENCE

(71) Applicant: Nokia Corporation, Espoo (FI)

(72) Inventors: Sujeet Shyamsundar Mate, Tampere (FI); Igor Danilo Diego Curcio, Tampere (FI)

(73) Assignee: Nokia Corporation, Espoo (FI)

(21) Appl. No.: 14/080,854

(22) Filed: Nov. 15, 2013

(51) Int. Cl. H04N 5/265; H04N 5/765

(52) U.S. Cl. CPC H04N 5/265; H04N 5/765
USPC 386/223

(57) ABSTRACT

A method, apparatus, and computer program product are disclosed to create media mixes and summaries using crowd-sourced intelligence. In the context of a method, sensor and context data is received from at least one device. The method includes causing generation of a media remix based on the sensor and context data received from the at least one device. In addition, the method includes causing transmission of the media remix to a client device. In some embodiments, the sensor data from the at least one device comprises at least one selected from the group consisting of: orientation with respect to north; orientation with respect to horizontal; position in three dimensional space; GPS data; or location data, and the context data from the at least one device enables calculation of the depth of focus of the at least one device. A corresponding apparatus and computer program product are also provided.

### TECHNOLOGICAL FIELD

Example embodiments of the present invention relate generally to automated media generation and, more particularly, to a method, apparatus, and computer program product for utilizing crowd-sourced intelligence to automatically create remixes and summaries of events.

### BACKGROUND

The use of image capturing devices has become prevalent in recent years as a variety of mobile devices, such as cellular telephones, video recorders, and other devices having cameras or other image capturing devices have become standard personal accessories. As such, it has become common for a plurality of people who are attending an event to separately capture video of the event. For example, multiple people at a sporting event, a concert, a theater performance or the like may capture video of the performers. Although each of these people may capture video of the same event, the video captured by each person may be somewhat different. For instance, the video captured by each person may be from a different angle or perspective and/or from a different distance relative to the playing field, the stage, or the like. Additionally or alternatively, the video captured by each person may focus upon different performers or different combinations of the performers.

Accordingly, it may be desirable to mix the videos captured by different people. However, efforts to mix the videos captured by a number of different people of the same event have proven to be challenging, particularly in instances in which the people who are capturing the video are unconstrained in regards to their relative position to the performers and in regards to the performers who are in the field of view of the videos.

The content capturing capabilities of mobile devices have improved much more quickly than network bandwidth, connection speed, and geographical distribution. Accordingly, there is great value to an end user if video can be recorded and value added content generated without the need for uploading, from a mobile device, large amounts of data, which is inherent to video recording. Some work has been done to generate panoramic views of events using ultra-high resolution video capturing equipment arranged contiguously to create a 360 degree view coverage of a venue (e.g., the FASCINATE project). This work has become possible due to the leaps in the media capture and network capabilities.

However, capitalizing on the ability to capture ultra-high resolution video using a thin client mobile device requires overcoming several hurdles. The biggest problem is that because bandwidth has not increased at a similar rate as video capturing capabilities, uploading high quality video content for generating value added content like remixes, summaries, etc. can often be impractical. In addition, however, the disparity in the media capture quality of recording devices and the potential absence of users in key spots on the field may result in gaps in event coverage (both spatial and temporal).

Finally, even in conjunction with an ultra-high resolution contiguous video capturing system, another problem is an inability to automatically find out an appropriate view selection for a remix or summary of an event. In this regard, the main problem is related to determining the most relevant and interesting parts that should be included in a particular representation (based on the selection of a view) of the event, since most of the commonly available viewing apparatus will not match the dimensions, resolution, or connectivity to view the complete recorded content (i.e. the 360 degree view). First, for viewing the high resolution panoramic video content, a very high resolution display of large size is needed which is not readily available. Second, the network bandwidth needed to support the transmission of such high bit rate is also not readily available. Prior art systems have a drawback in that the intelligence for view selection is limited to single user's choice. Accordingly, there is a need to generate a more representative remix and/or summary of an event that takes into account the viewing preferences of an entire crowd.

### BRIEF SUMMARY

Accordingly, a method, apparatus, and computer program product are provided to utilize crowd-sourced intelligence to automatically create remixes and summaries of events. In this regard, a method, apparatus and computer program product are provided to collect sensor and context data from a variety of thin client devices for use in automatic remix creation.

In a first example embodiment, a method is provided that includes receiving sensor and context data from at least one device, causing, by a processor, generation of a media remix based on the sensor and context data received from the at least one device, and causing transmission of the media remix to a client device. In this regard, the sensor data from the at least one device comprises at least one selected from the group consisting of: orientation with respect to north; orientation with respect to horizontal; position in three dimensional space; global positioning system (GPS) data; or location data, and the context data from the at least one device enables calculation of the depth of focus of the at least one device. Moreover, causing generation of the media remix may further be based on the sensor and context data of the client device.

In some embodiments, generation of the media remix includes identifying at least one focus of interest based on the sensor and context data, extracting relevant media segments from a recording engine based on candidate views corresponding to the at least one focus of interest, and generating the media remix based on the relevant media segments. In one such embodiment, identifying the at least one focus of interest based on the sensor and context data includes determining a location, orientation, and area of focus of the at least one device based on the sensor and context data, and identifying the at least one focus of interest based on the location, orientation, and area of focus of the at least one device. In another such embodiment, generation of the media remix further includes identifying the candidate views corresponding to the at least one focus of interest by evaluating candidate views from the recording engine based on at least one of: a comparison of distance of focus of the candidate view to distance of focus of the focus of interest, a comparison of an orientation of the candidate view with respect to the focus of interest, and detectability of the focus of interest in the candidate view using object detection or object recognition analysis; and selecting candidate views from the recording engine based on the evaluation. In yet another such embodiment, the media segments comprise audio or video segments.

In another example embodiment, an apparatus is provided having at least one processor and at least one memory including computer program code, the at least one memory and the computer program code configured to, with the at least one processor, cause the apparatus to receive sensor and context data from at least one device, generate a media remix based on the sensor and context data received from the at least one device, and transmit the media remix to a client device. In this regard, generating the media remix may be further based on the sensor and context data of the client device.

In some embodiments of the apparatus, the at least one memory and the computer program code are configured to, with the at least one processor, cause the apparatus to generate the media remix by identifying at least one focus of interest based on the sensor and context data, extracting relevant media segments from a recording engine based on candidate views corresponding to the at least one focus of interest, and generating the media remix based on the relevant media segments. In one such example, identifying the at least one focus of interest based on the sensor and context data comprises determining a location, orientation, and area of focus of the at least one device based on the sensor and context data, and identifying the at least one focus of interest based on the location, orientation, and area of focus of the at least one device. In another such example, generating the media remix further comprises identifying the candidate views corresponding to the at least one focus of interest by evaluating candidate views from the recording engine based on at least one of: a comparison of distance of focus of the candidate view to distance of focus of the focus of interest, a comparison of an orientation of the candidate view with respect to the focus of interest, and detectability of the focus of interest in the candidate view using object detection or object recognition analysis; and selecting candidate views from the recording engine based on the evaluation. In yet another such embodiment, the media segments comprise audio or video segments.

In another example embodiment, a computer program product is provided that includes at least one non-transitory computer-readable storage medium having computer-executable program code portions stored therein with the computer-executable program code portions comprising program code instructions that, when executed, cause an apparatus to receive sensor and context data from at least one device, generate a media remix based on the sensor and context data received from the at least one device, and transmit the media remix to a client device. In this regard, generating the media remix is further based on the sensor and context data of the client device.

In some embodiments, the program code instructions, when executed, cause the apparatus to generate the media mix comprise program code instructions that, when executed, cause the apparatus to identify at least one focus of interest based on the sensor and context data, extract relevant media segments from a recording engine based on candidate views corresponding to the at least one focus of interest, and generate the media remix based on the relevant media segments. In one such embodiment, the program code instructions that, when executed, cause the apparatus to identify the at least one focus of interest based on the sensor and context data comprise program code instructions that, when executed, cause the apparatus to determine a location, orientation, and area of focus of the at least one device based on the sensor and context data, and identify the at least one focus of interest based on the location, orientation, and area of focus of the at least one device. In another such embodiment, generating the media remix further comprises identifying the candidate views corresponding to the at least one focus of interest by evaluating candidate views from the recording engine based on at least one of: a comparison of distance of focus of the candidate view to distance of focus of the focus of interest, a comparison of an orientation of the candidate view with respect to the focus of interest, and detectability of the focus of interest in the candidate view using object detection or object recognition analysis; and selecting candidate views from the recording engine based on the evaluation.

In another example embodiment, an apparatus is provided that includes means for receiving sensor and context data from at least one device, means for generating a media remix based on the sensor and context data received from the at least one device, and means for transmitting the media remix to a client device.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an example network configuration, in accordance with an example embodiment of the present invention;

FIG. 2 shows a block diagram of an apparatus that may be specifically configured in accordance with an example embodiment of the present invention;

FIGS. 3A and 3B illustrate event venues, in accordance with an example embodiment of the present invention;

FIG. 4 shows a block diagram of a system for generating media remixes based on crowd-sourced intelligence, in accordance with an example embodiment of the present invention;

FIG. 5 shows another block diagram of a system for generating media remixes based on crowd-sourced intelligence, in accordance with an example embodiment of the present invention;

FIG. 6 illustrates a flowchart describing example operations performed for generating media remixes and summaries based on crowd-sourced intelligence, in accordance with some example embodiments;

FIG. 7 illustrates a flowchart describing example operations for generating a media remix or summary, in accordance with some example embodiments;

FIG. 8 illustrates a flowchart describing example operations for identifying at least one focus of interest based on sensor and context data, in accordance with some example embodiments; and

FIG. 9 illustrates a flowchart describing example operations for identifying the candidate views corresponding to the at least one focus of interest, in accordance with some example embodiments.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

As referred to herein, a focus of interest (also referred to herein interchangeably as a focus point of interest or as a focus point) may denote any part of an event (e.g., a public event), including but not limited to, a field, a stage or the like that is more interesting than other parts of the event. An event may, but need not, correspond to one or more focus points during the event.

In an example embodiment, a focus of interest may be determined in an instance in which thin clients of multiple users are observed to point to an area or location in the event. This may be achieved using one or more (or a combination) of sensor or context data captured by the thin client devices during the event. The sensor data may include, but is not limited to, a horizontal orientation detected by a magnetic compass sensor, a vertical orientation detected by an accelerometer sensor, gyroscope sensor data (e.g., for determining roll, pitch, yaw, etc.), location data (e.g., determined by a Global Positioning System (GPS), an indoor position technique, or any other suitable mechanism). Additionally, the context data captured by the thin client devices may include zoom information generated by a viewfinder, and/or color adjustment information.

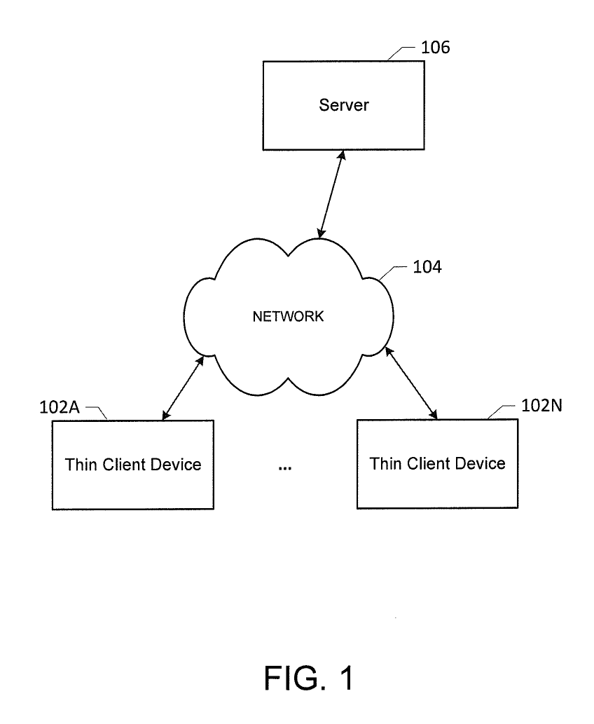

FIG. 1 illustrates a generic system diagram in which a device, such as a thin client terminal 102 is shown in an example communication environment. As shown in FIG. 1, an embodiment of a system in accordance with an example embodiment of the invention may include a first thin client device (TCD) 102A and any number of additional thin client devices 102N capable of communicating with each other via a network 104. In one embodiment, not all systems that employ an embodiment of the present invention may comprise all the devices illustrated and/or described herein. Thin client devices 102A through 102N may comprise smartphones, but may also, in some embodiments, comprise other devices such as portable digital assistants (PDAs), tablets, pagers, mobile televisions, mobile telephones, gaming devices, laptop computers, cameras, tablet computer, video recorders, web camera, audio/video players, radios, global positioning system (GPS) devices, Bluetooth headsets, Universal Serial Bus (USB) devices, any other devices configured to capture sensor and context data, or any combination of the aforementioned. Furthermore, devices that are not mobile, such as servers and personal computers may employ some embodiments of the present invention in certain contexts (e.g., when physical deployed in relevant proximity to a recorded event).

The network 104 may include a collection of various different nodes (of which thin client devices 102A through 102N may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 104. Although not necessary, in one embodiment, the network 104 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self-optimizing/Organizing Network (SON) intra-LTE, inter-Radio Access Technology (RAT) Network and/or the like. In one embodiment, the network 104 may be a peer-to-peer (P2P) network.

Thin client devices 102A through 102N may be in communication with each other via the network 104 and may each include an antenna or antennas for transmitting signals to and for receiving signals from one or more base sites. The base sites could be, for example one or more base stations (BS) that are a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the communication devices 102A through 102N via the network 104. By directly or indirectly connecting the thin client devices 102A through 102N (and/or other devices) to the network 104, the thin client devices 102A through 102N may communicate with each other or with the other devices. In this regard, the thin client devices 102A through 102N may communicate according to numerous communication protocols including Hypertext Transfer Protocol (HTTP), Real-time Transport Protocol (RTP), Session Initiation Protocol (SIP), Real Time Streaming Protocol (RTSP) and/or the like, to carry out various communication or other functions.

Furthermore, although not shown in FIG. 1, the thin client devices 102A through 102N may communicate in accordance with, for example, Radio Frequency (RF), Near Field Communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the communication devices 102A through 102N may be enabled to communicate with the network 104 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the network 104 may be an ad hoc or distributed network arranged to be a smart space. Thus, devices may enter and/or leave the network 104 and the devices connected to the network 104 may be capable of adjusting operations based on the entrance and/or exit of other devices to account for the addition or subtraction of respective devices or nodes and their corresponding capabilities.

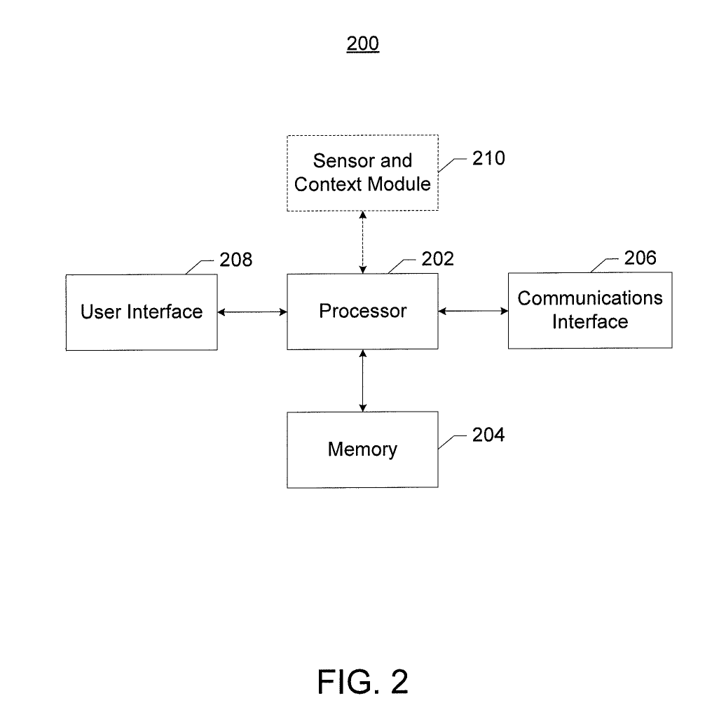

In an example embodiment, the thin client devices 102A through 102N may embody an apparatus 200 (illustrated in FIG. 2) capable of employing embodiments of the invention.

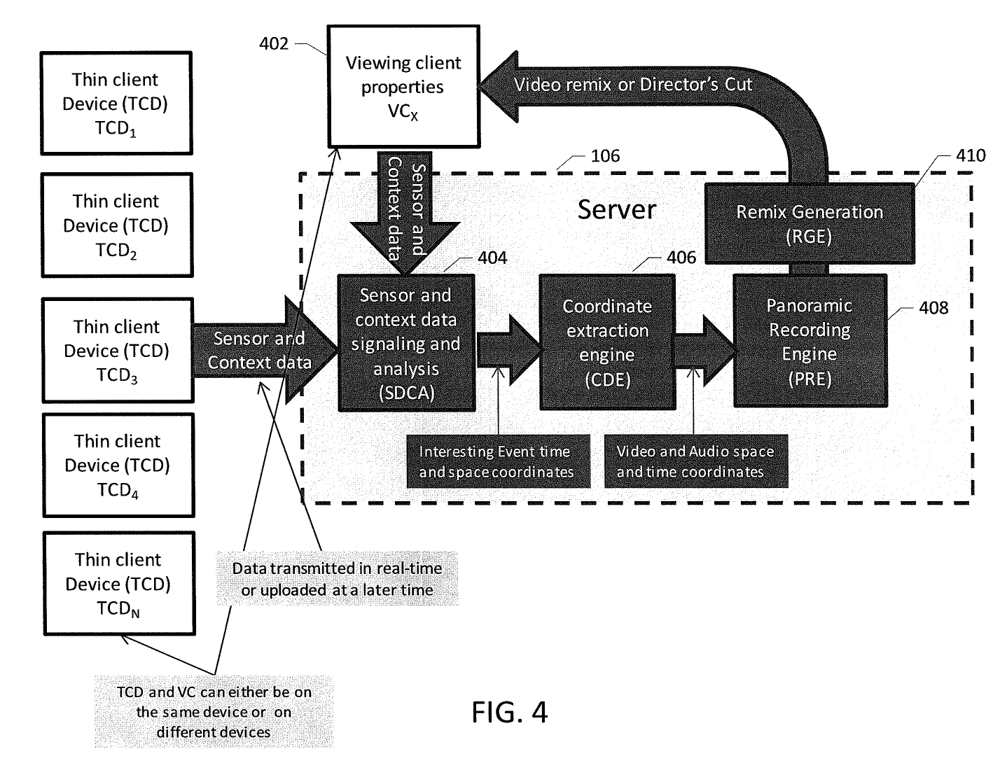

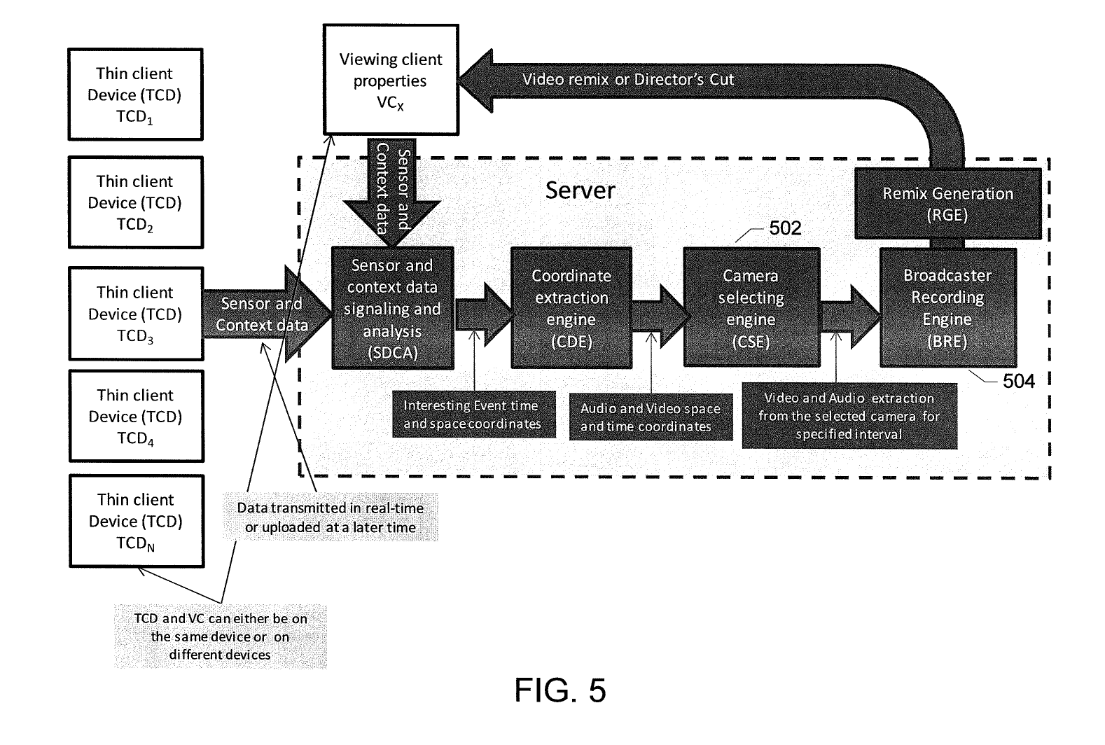

Moreover, the server 106 may also embody an apparatus 200, which receives sensor and context data from thin client devices 102A through 102N, and which may utilize the sensor and context data to generate one or more remixes or summaries of an event, as illustrated in FIGS. 4 and 5. It should be noted that while FIG. 2 illustrates one example configuration, numerous other configurations may also be used to implement embodiments of the present invention. As such, in some embodiments, although elements are shown as being in communication with each other, hereinafter such elements should be considered to be capable of being embodied within the same device or within separate devices.

Referring now to FIG. 2, the apparatus 200 may include or otherwise be in communication with a processor 202, memory device 204, communication interface 206, user interface 208, and, optionally, sensor and context module 210. In some embodiments, the processor (and/or co-processor or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 200 may be embodied by a computing device, such as a computer terminal. However, in some embodiments, the apparatus may be embodied as a chip or chip set. In other words, the apparatus may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 202 may be configured to execute instructions stored in the memory device 204 or otherwise accessible to the processor. Alternatively or additionally, the processor may be configured to execute hard-coded functionality. As such, whether configured by hardware or software methods, or by a combination thereof, the processor 202 may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 206 may be any means such as a device or circuitry embodied in either hardware or a combination of hardware and software that is configured to receive and/or transmit data from/to a network and/or any other device or module in communication with the apparatus 200. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

The apparatus 200 may include a user interface 208 that may, in turn, be in communication with processor 202 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory device 204, and/or the like).

The apparatus 200 may also include a sensor and context module 210, in embodiments of thin client devices 102N (embodiments of server 106, however, need not include sensor and context module 210). Sensor and context module 210 may include positioning sensors (e.g., gyroscope, accelerometer, compass, altimeter, or the like), location sensors (e.g., GPS, Indoor-Positioning, WIFI/BT positioning, or the like), or any other sensors, context gathering elements (e.g., a viewfinder or the like), and relevant context data (e.g., size and characteristics of a display, such as whether it is a single view or multi-view (e.g., three dimensional) display and any requisite color adjustment requirements, audio rendering characteristics, or the like) accessible by processor 204. The sensor and context module 210 may accordingly comprise any means for capturing sensor and context data by a thin client device 102 during an event. As noted above, the sensor data may include, but is not limited to, a horizontal orientation detected by a magnetic compass, a vertical orientation detected by an accelerometer, gyroscope data (e.g., for determining roll, pitch, yaw, etc.), or location data (e.g., determined by a Global Positioning System (GPS), an indoor position technique, or any other suitable mechanism). Additionally, the context data captured by the thin client devices may include zoom information generated by a viewfinder, and/or any of the relevant context data identified above. In this regard, the viewfinder may either be a conventional viewfinder that is available in most digital cameras or it may also be a wearable device. The viewfinder can be used by the user to zoom in and out of the scene (context data that may be captured by sensor and context module 210), even though no video need be recorded by the device. The apparatus 200 embodying a thin client device 102N may be configured to send the sensor data and context information to the sensor and context data signaling and analysis (SDCA) module of server 106, described below in connection with FIGS. 4 and 5.

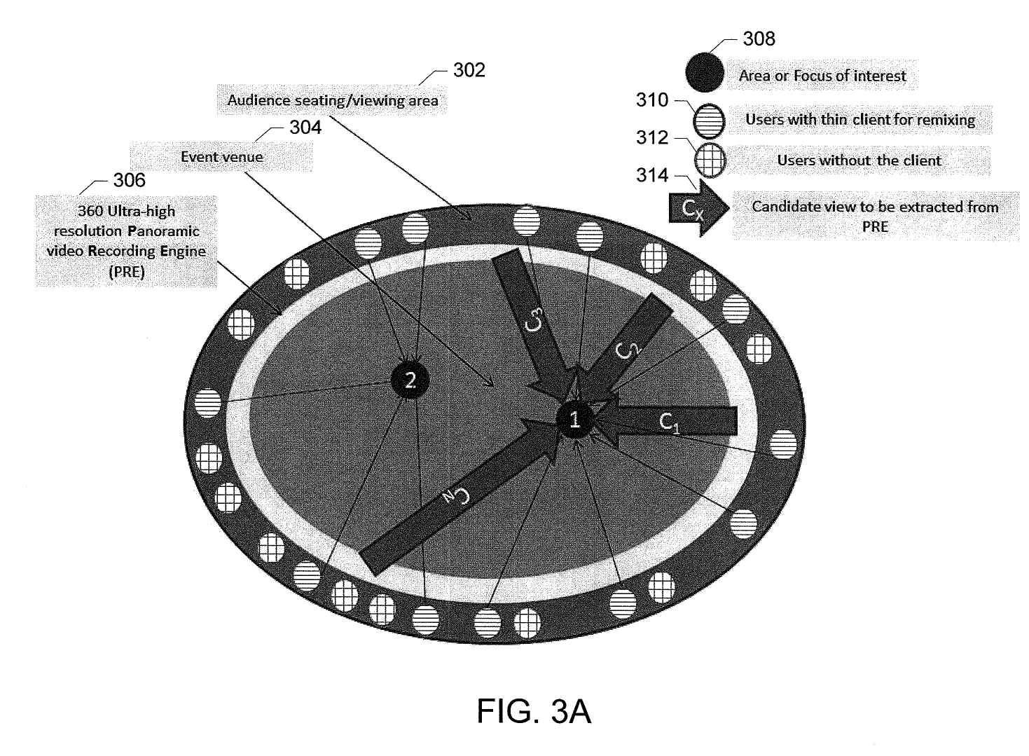

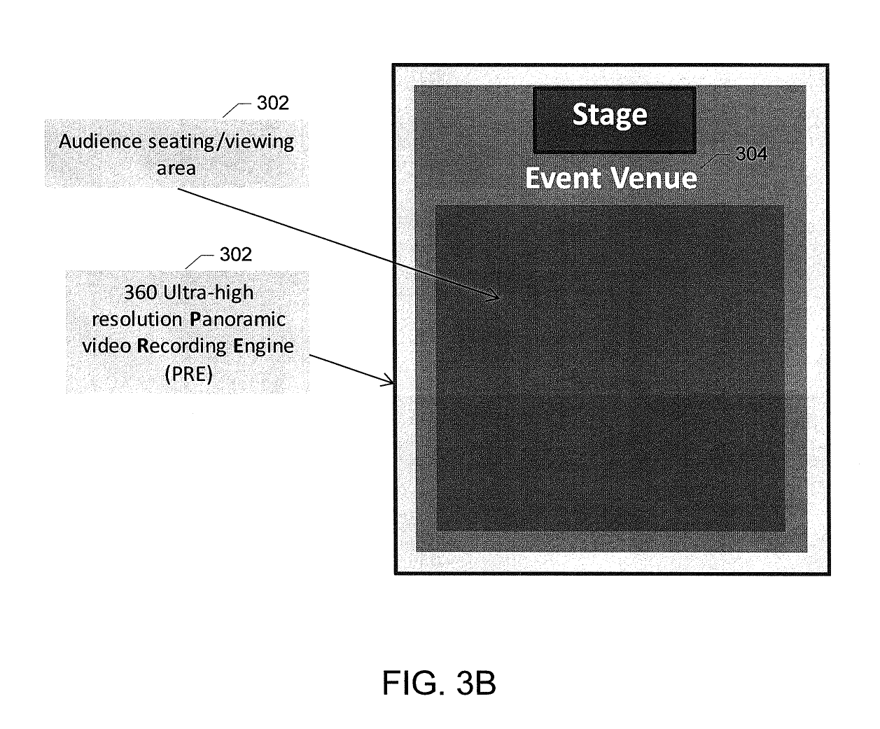

Turning now to FIGS. 3A and 3B, illustrative examples are shown in which embodiments of the present invention may be employed. FIG. 3A depicts a stadium-like setting, such as a venue where a sports game or concert will take place. As shown in FIG. 3A, the audience seating/viewing area 302 encircles the event venue 304, and an ultra-high resolution 360 panoramic video recording arrays connected to the panoramic video recording engine (PRE) 306 also encircles the event venue 304, and records the audio and video. FIG. 3B shows another type of venue where an event may take place. As shown in FIG. 3B, the audience seating/viewing area 302 is to one side of the event venue 304, although the ultra-high resolution 360 panoramic video recording arrays connected to the panoramic video recording engine (PRE) 306 may still encircle the event venue 304 to record the audio and video.

In some embodiments of the invention, the users are present in the audience seating/viewing area with thin client devices 102N, each of which comprises an apparatus 200 equipped with a sensor and context module 210. In this regard, the thin client devices 102N may optionally be equipped with network connectivity and a viewfinder apparatus. The network connectivity enables the thin client devices 102N to transmit low bitrate context and sensor data to the server 106 in real-time, deferred real-time or later upload depending on the application implementation.

Turning now to FIG. 4, a thin client remix creation system is illustrated, in accordance with some example embodiments. As shown in FIG. 4, during an event in a venue (such as those shown in FIG. 3A or 3B), many individuals in the audience may carry thin client devices 102, such as TCD₁ through TCD_{N}, each embodied by an apparatus 200 having a sensor and context module 210. Accordingly, the location and position information of the users recording at the event with their thin client mobile devices is determined continuously using the sensor equipped thin clients. The frequency of collection of sensor and context data can be determined based on application requirements and a desired level of granularity. High granularity enables the position and change in position of the user's recording field of view with higher accuracy and subsequently result in generating a more accurate view map of the user, but, of course, may not be required for all implementations. Accordingly, during example embodiments of the present invention, each particular individual in the audience may view the event as he/she normally would using his/her conventional video recording device; however, the thin client device need not record the video to be used to generate a remix, however, and can therefore record only this sensor and context data, such as how the camera was moved and what were the changes in the zoom settings of a virtual camera.

In example embodiments, a particular viewing client 402 who may wish to receive a media remix or summary, and who may or may not be one of TCD₁ through TCD_{N}, also gathers sensor and context data. The position of the thin client devices (TCD₁ through TCD_{N}) and viewing client 402 in 3D space and location information are transmitted to server 106, and in particular to the sensor and context signaling and analysis (SDCA) module 404 of server 106 for use in generating the media remix or summary.

SDCA module 404 is configured to take the sensor and context data from the thin client devices to determine focus points of interest from the event, temporally and spatially, which are then passed to coordinate extraction engine (CDE) 406 of server 106. The SDCA module of the system received data from the TCSs to determine the candidate views of interest to the crowd in the event. In some embodiments, the SDCA takes into account the sensor and context data of the viewing client 402, in addition to sensor and context data from the TCDs.

After determining the focus points of interest, CDE 406 compares the crowd source area or focus of interest to the orientation and camera settings to find the camera views that match the focus points of interest of the event. Server 106 detects the focus points of interest of the event using the individual and collective movements of the recording devices carried by the plurality of users attending the event. The focus points of interest may also be detected and classified using the focus of interest enabler disclosed in U.S. patent application Ser. No. 13/345,143, filed Jan. 6, 2012, the entire contents of which are incorporated by reference herein.

The coordinates automatically generated by CDE 406 can include more than one set of candidate views, out of which the CDE 406 may extract the most suitable candidate views based on one or more of the following: (1) object detection and/or object recognition, such that the CDE 406 gathers the view angle oriented such that an object of interest (e.g., a face) is seen from an appropriate angle (e.g., the front); (2) focus of interest visibility, such that the focus of interest is visible in a manner that is closest to the ideal reference viewing angle available; and (3) proximity, such that the focus of interest is closest to the recording cameras associated with the PRE. In this fashion, the CDE 406 is able to select the coordinates of the best views of focus points of interest. In one embodiment, the coordinates of candidate views of the focus points of interest are based on the viewing client's (VC's) sensor and context data (e.g., display characteristics, audio rendering characteristics, or the like). For instance, the candidate views may be from the estimated perspective of the viewing client's device. There may be multiple area or focus points of interest in an event. Accordingly, for each focus of interest, candidate views C₁, C₂, C₃, through C_{N} may be generated, as show in FIG. 3A. As disclosed below, server 106 may then extract the candidate views automatically from the PRE (accessed via PRE module 408) for potential inclusion in a media remix or summary.

As noted above, the PRE 408 stores the various views retrieved from the associated ultra-high resolution cameras. In some embodiments, there could be multiple sets of 360 degree panoramic camera apparatuses recording at multiple zoom levels and depth of field, thereby enabling selection by CDE 406 of views from PRE 408 that accord more closely with zoom settings suggested by the crowd-sourced intelligence or captured by the viewing client's device.

Subsequently, the plurality of high quality cameras located at the event venue are leveraged by remix generation engine 410 to generate the crowd sourced remix or summary version of the event. In this regard, for each focus point of interest, the camera view that most closely matches the crowd-sourced intelligence (or viewing client's device sensor or context data) is chosen for inclusion in the automatic remix or summary version. To achieve this result, remix generation engine (RGE) 410 of server 106 uses the coordinates provided by CDE 406 to extract spatially and temporally relevant video segments from the PRE 408, and to generate the video segment of the remix. Similarly, RGE 410 extracts audio scene recordings, captured by an audio-capturing apparatus, which are closest to the spatial location of the extracted video segment for the temporal interval of duration that equals the temporal duration of the extracted video segment. Accordingly, all spatio-temporally relevant video and corresponding audio segments are extracted from the recorded content. In RGE 410, the audio segments are spliced to generate the audio track and video segments are spliced to generate the video track. Finally, server 106 packs together the audio track and the video track in a suitable file format for delivery to the viewing client. As a result, the viewing client is able to retrieve an individually tailored media remix via any preferred method of sharing.

Notably, as a result of the above-described operations, the viewing client's device may be a simple device with only a viewfinder and internet connectivity, in addition to sensors. In this case, because the high resolution content is already being captured by the PRE 408, the thin client device need only be able to transmit sensor data to the server, thus tremendously reducing the amount of data that needs to be uploaded to generate a media remix or summary. In another embodiment, the thin client device may be a simple wearable device with in-built positioning sensors to generate individual user's viewing information, which is subsequently used to generate the crowd-sourced media remix or summary from the recorded high resolution content gathered from PRE 408. In yet another example embodiment, users may carry a very rudimentary low-cost device consisting of only the positioning and location sensor which records the head movements of the user during the event, which can then be transferred to the server for providing a personalized view of the event in addition to the automatic remix or summary of the event that is based on the focus points of interest identified via crowd-sourced intelligence.

Turning now to FIG. 5, another thin client remix creation system is illustrated, in accordance with some example embodiments. In this embodiment, the PRE camera array apparatus could be replaced by a plurality of high quality video cameras in the arena and referred to as a broadcaster recording engine (BRE). The BRE module contains all the recorded content from the event stored for each camera located in the arena. The crowd-sourced intelligence is used to determine the best available candidate view from the available camera views. This can be feasible even today, since there are already many events that include a large number of high quality professional cameras for TV broadcast. As an extension, the user motion/movement of the professional high quality cameras is tracked using add-on sensor package or built-in sensor packages that include GPS/location sensor, accelerometer, compass, gyroscope, and/or camera focal length and zoom information.

Accordingly, in this embodiment shown in FIG. 5, a crowd source intelligence engine (CSE) of server 106 compares the focus points of interest determined by the crowd-sourced intelligence with the professional cameras' orientations and other above mentioned parameters at that instant, to find the camera that suites or matches best with the crowd source intelligence. The camera view that matches best is chosen to be included in the automatic remix or summary generated by server 106. Thus, the embodiment shown in FIG. 5 provides additional means for generating crowd source remixes or summaries from professionally recorded content. In addition to generating a remix that more closely aligns with the interests of the crowd, this embodiment also provides directors with the ability to determine what events and occurrences were of more interest to the crowd in the stadium than the media included in the director's original version of telecast.

In some embodiments of FIGS. 4 and 5 above, the functionalities of the server 106 can be physically located in a single computer or realized in separate computer parts of a distributed network. In this regard, the functions may be realized in a different network topology, such as a peer-to-peer network.

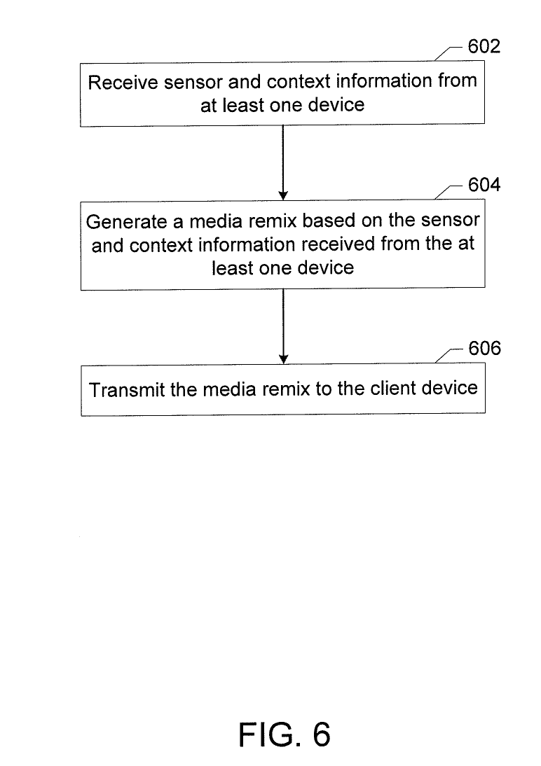

FIG. 6 illustrates a flowchart containing a series of operations performed to generate media remixes and summaries based on crowd-sourced intelligence. The operations illustrated in FIG. 6 may, for example, be performed by, with the assistance of, and/or under the control of one or more of processor 204, memory 208, user interface 202, or communications interface 206.

In operation 602, apparatus 200 includes means, such as processor 204, the communications interface 206, or the like, for receiving sensor and context data from at least one device. In this regard, the sensor data may comprise at least one selected from the group consisting of: orientation with respect to north; orientation with respect to horizontal; position in three dimensional space; global positioning system (GPS) data; or location data. Moreover, the context data may enables calculation of the depth of focus of the at least one device. In some embodiments, this context data may comprise at least one selected from the group consisting of zoom data and display characteristics.

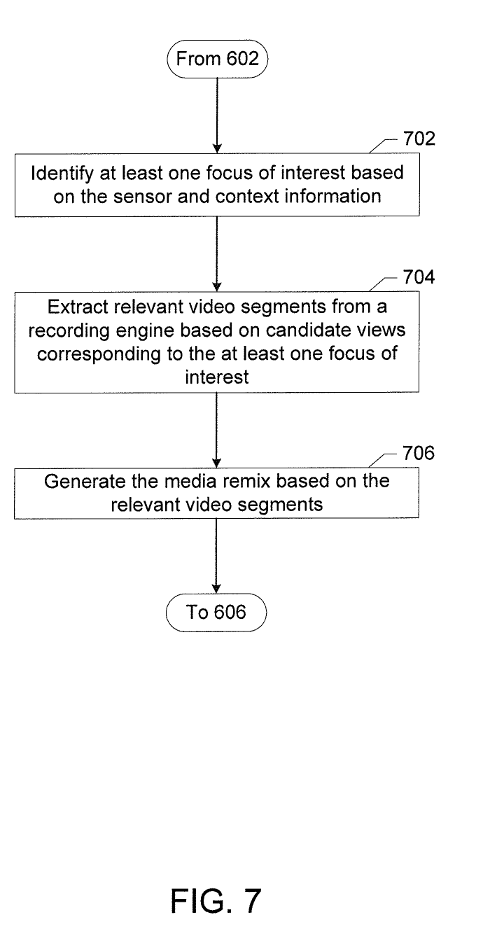

In operation 604, the apparatus 200 further includes means, such as processor 204 or the like, for causing generation of a media remix based on the sensor and context data received from the at least one device, as will be described in greater detail below in conjunction with FIG. 7. In some embodiments, however, causing generation of the media remix is further based on the sensor and context data of the client device.

Thereafter, in operation 606, the apparatus 200 may include means, such as processor 204 or the like, for causing transmission of the media remix to a client device.

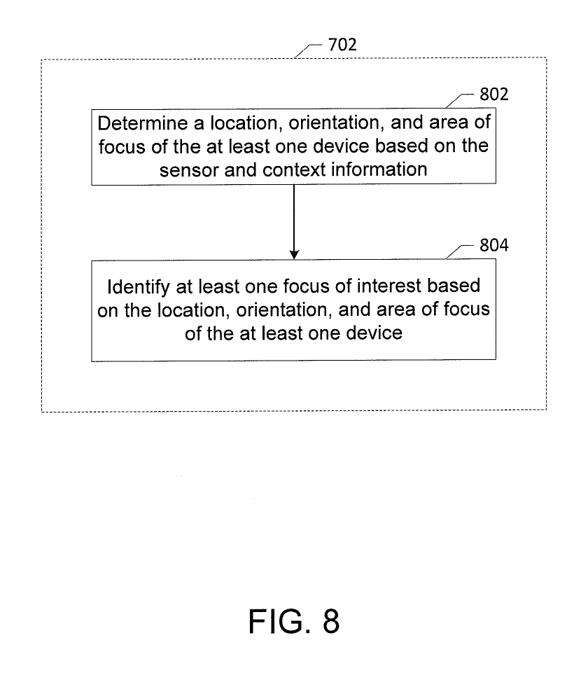

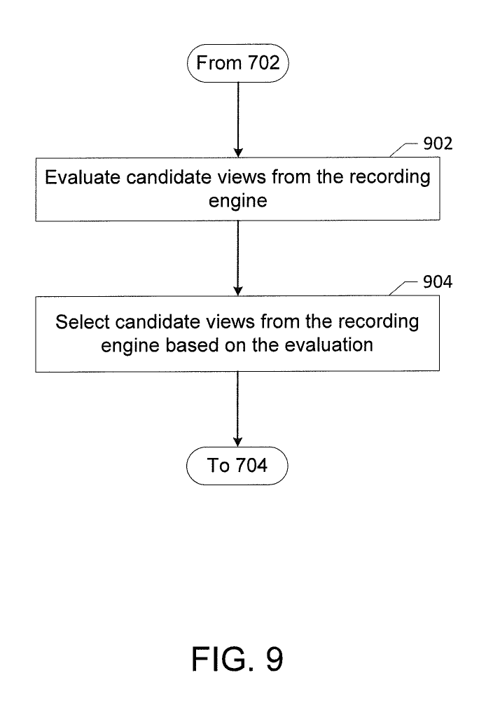

Turning now to FIG. 7, a flowchart is shown that describes example embodiments for generating a media remix or summary. In operation 702, the apparatus 200 may further include means, such as the processor 204 or the like, for identifying at least one focus of interest based on the sensor and context data, as will be described in greater detail below with respect to FIG. 8. In operation 704, the apparatus 200 may further include means, such as the processor 204, communication device 206, or the like, for extracting relevant media segments (e.g., audio or video segments) from a recording engine based on candidate views corresponding to the at least one focus of interest. In this regard, identifying the candidate views is discussed in greater detail with respect to FIG. 9 below.

In operation 706, the apparatus 200 may further include means, such as the processor 204 or the like, for generating the media remix or summary based on the relevant media segments.

Turning now to FIG. 8, a flowchart is shown that describes example operations for identifying at least one focus of interest based on sensor and context data. In operation 802, the apparatus 200 may include means, such as the processor 204 or the like, for determining a location, orientation, and area of focus of the at least one device based on the sensor and context data. In operation 804, the apparatus 200 may include means, such as the processor 204 or the like, for identifying the at least one focus of interest based on the location, orientation, and area of focus of the at least one device.

Turning now to FIG. 9, a flowchart is shown that describes example operations for identifying the candidate views corresponding to the at least one focus of interest. In operation 902, the apparatus 200 may include means, such as the processor 204 or the like, for evaluating candidate views from the recording engine based on at least one of: a comparison of distance of focus of the candidate view to distance of focus of the focus of interest, a comparison of an orientation of the candidate view with respect to the focus of interest, and detectability of the focus of interest in the candidate view using object detection or object recognition analysis. In some embodiments, the object detection/recognition analysis may comprise facial detection and/or recognition.

In operation 904, the apparatus 200 may further include means, such as processor 204, memory 208, or the like, for selecting candidate views from the recording engine based on the evaluation.

As described above, example embodiments of the present invention utilize crowd-sourced intelligence to automatically create remixes and summaries of events for distribution to a thin client device. As a result, embodiments of the present invention generate remixes and/or summaries without a user having to consciously record and/or upload content. Accordingly, the remixes and/or summaries may be generated without the user having to upload large amounts of content, even though the user is still able to access a high quality remix automatically. Moreover, through the use of a recording engine, embodiments of the present invention may generate remixes and/or summaries in the absence of high quality capturing equipment being employed by individuals in the crowd.

As described above, FIGS. 6-9 illustrate flowcharts of the operation of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which preform the specified functions, or combinations of special purpose hardware and computer instructions.

In some embodiments, certain ones of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving sensor and context data from at least one device;
causing, by a processor, generation of a media remix based on the sensor and context data received from the at least one device; and
causing transmission of the media remix to a client device.

2. The method of claim 1,
wherein the sensor data from the at least one device comprises at least one selected from the group consisting of: orientation with respect to north; orientation with respect to horizontal; position in three dimensional space; global positioning system (GPS) data; or location data, and
wherein the context data from the at least one device enables calculation of the depth of focus of the at least one device.

3. The method of claim 1, wherein generation of the media remix comprises:
identifying at least one focus of interest based on the sensor and context data;
extracting relevant media segments from a recording engine based on candidate views corresponding to the at least one focus of interest; and
generating the media remix based on the relevant media segments.

4. The method of claim 3, wherein identifying the at least one focus of interest based on the sensor and context data comprises:
determining a location, orientation, and area of focus of the at least one device based on the sensor and context data; and
identifying the at least one focus of interest based on the location, orientation, and area of focus of the at least one device.

5. The method of claim 3, wherein generation of the media remix further comprises identifying the candidate views corresponding to the at least one focus of interest by:
evaluating candidate views from the recording engine based on at least one of:
a comparison of distance of focus of the candidate view to distance of focus of the focus of interest,
a comparison of an orientation of the candidate view with respect to the focus of interest, and
detectability of the focus of interest in the candidate view using object detection or object recognition analysis; and
selecting candidate views from the recording engine based on the evaluation.

6. The method of claim 3, wherein the media segments comprise audio or video segments.

7. The method of claim 1, wherein causing generation of the media remix is further based on the sensor and context data of the client device.

8. An apparatus comprising at least one processor and at least one memory including computer program code, the at least one memory and the computer program code configured to, with the at least one processor, cause the apparatus to:
receive sensor and context data from at least one device;
generate a media remix based on the sensor and context data received from the at least one device; and
transmit the media remix to a client device.

9. The apparatus of claim 8,
wherein the sensor data from the at least one device comprises at least one selected from the group consisting of: orientation with respect to north; orientation with respect to horizontal; position in three dimensional space; GPS data; or location data, and
wherein the context data from the at least one device enables calculation of the depth of focus of the at least one device.

10. The apparatus of claim 8, wherein the at least one memory and the computer program code are configured to, with the at least one processor, cause the apparatus to generate the media remix by:
identifying at least one focus of interest based on the sensor and context data;
extracting relevant media segments from a recording engine based on candidate views corresponding to the at least one focus of interest; and
generating the media remix based on the relevant media segments.

11. The apparatus of claim 10, wherein identifying the at least one focus of interest based on the sensor and context data comprises:
determining a location, orientation, and area of focus of the at least one device based on the sensor and context data; and
identifying the at least one focus of interest based on the location, orientation, and area of focus of the at least one device.

12. The apparatus of claim 10, wherein generating the media remix further comprises identifying the candidate views corresponding to the at least one focus of interest by:
evaluating candidate views from the recording engine based on at least one of:
a comparison of distance of focus of the candidate view to distance of focus of the focus of interest,
a comparison of an orientation of the candidate view with respect to the focus of interest, and
detectability of the focus of interest in the candidate view using object detection or object recognition analysis; and
selecting candidate views from the recording engine based on the evaluation.

13. The apparatus of claim 10, wherein the media segments comprise audio or video segments.

14. The apparatus of claim 8, wherein generating the media remix is further based on the sensor and context data of the client device.

15. A computer program product comprising at least one non-transitory computer-readable storage medium having computer-executable program code portions stored therein, the computer-executable program code portions comprising program code instructions that, when executed, cause an apparatus to:
receive sensor and context data from at least one device;
generate a media remix based on the sensor and context data received from the at least one device; and
transmit the media remix to a client device.

16. The computer program product of claim 15,
wherein the sensor data from the at least one device comprises at least one selected from the group consisting of: orientation with respect to north; orientation with respect to horizontal; position in three dimensional space; GPS data; or location data, and
wherein the context data from the at least one device enables calculation of the depth of focus of the at least one device.

17. The computer program product of claim 15, wherein the program code instructions that, when executed, cause the apparatus to generate the media mix comprise program code instructions that, when executed, cause the apparatus to:
identify at least one focus of interest based on the sensor and context data;
extract relevant media segments from a recording engine based on candidate views corresponding to the at least one focus of interest; and
generate the media remix based on the relevant media segments.

18. The computer program product of claim 17, wherein the program code instructions that, when executed, cause an apparatus to identify the at least one focus of interest based on the sensor and context data comprise program code instructions that, when executed, cause the apparatus to:
determine a location, orientation, and area of focus of the at least one device based on the sensor and context data; and
identify the at least one focus of interest based on the location, orientation, and area of focus of the at least one device.

19. The computer program product of claim 17, wherein generation of the media remix further comprises identifying the candidate views corresponding to the at least one focus of interest by:
evaluating candidate views from the recording engine based on at least one of:
a comparison of distance of focus of the candidate view to distance of focus of the focus of interest,
a comparison of an orientation of the candidate view with respect to the focus of interest, and
detectability of the focus of interest in the candidate view using object detection or object recognition analysis; and
selecting candidate views from the recording engine based on the evaluation.

20. The computer program product of claim 1, wherein generating the media remix is further based on the sensor and context data of the client device.
